(19) United States
(12) Patent Application Publication
(10) Pub. No.: US 2025/0247846 A1
(43) Pub. Date: Jul. 31, 2025

(54) METHOD AND APPARATUS FOR HANDLING DELAY STATUS REPORT FOR EXTENDED REALITY IN A WIRELESS COMMUNICATION SYSTEM

(71) Applicant: SAMSUNG ELECTRONICS CO., LTD., Suwon-si (KR)

(72) Inventors: Vinay Kumar SHRIVASTAVA, Bangalore (IN); Sriganesh RAJENDRAN, Bangalore (IN)

(21) Appl. No.: 19/039,672

(22) Filed: Jan. 28, 2025

(30) Foreign Application Priority Data
Jan. 30, 2024 (IN) 202441006182
Jan. 15, 2025 (IN) 202441006182

(51) Int. Cl. H04W 72/1268; H04W 28/02

(52) U.S. Cl. CPC H04W 72/1268; H04W 28/0236

(57) ABSTRACT

The disclosure relates to a 5G or 6G communication system for supporting a higher data transmission rate. Embodiments disclosed herein describe a method and user equipment (UE) for delay status report (DSR) handling for extended reality (XR) within a communication network system. The method involves the UE detecting a transmission of a medium access control (MAC) protocol data unit (PDU) or a cancellation of the DSR that triggered a scheduling request (SR) for the DSR. The UE stops an ongoing random access procedure initiated due to the SR for the DSR, wherein the SR for the DSR lacks configuration of valid physical uplink control channel (PUCCH) resources. This solution offers an enhanced DSR handling mechanism that ensures efficient transmission and better scheduling for the XR applications in wireless networks.

### CROSS-REFERENCE TO RELATED APPLICATIONS

The application is based on and claims priority under 35 U.S.C. § 119 to Indian Provisional Application 202441006182 filed on Jan. 30, 2024, and Indian Complete Application 202441006182 filed Jan. 15, 2025, in the Indian Intellectual Property Office, the disclosures of which are hereby incorporated by reference herein in their entirety.

### BACKGROUND

### 1. Field

The present application relates to communication network systems and more specifically relates to delay status report (DSR) handling for extended reality (XR) in a communication network system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The XR is an umbrella term that encompasses all immersive technologies including virtual reality (VR), augmented reality (AR), and mixed reality (MR), which blend the physical and digital worlds to create interactive, immersive experiences. These technologies are essential for realizing the concept of the digital twin or meta-universe, and are significant components of 5th generation (5G) and 5G-Advanced communication network systems. The 3rd generation partnership project (3GPP) Release 18 continues the development of 5G Advanced, which aims at improving 5G networks to support more demanding use cases, including XR. Release 18 focuses on optimizing the 5G network to meet XR's requirements, which include real-time immersive experiences, ultra-low latency, and high data rates.

The integration of XR services into existing and future wireless networks presents numerous challenges. The 3GPP new radio (NR) framework, which is tasked with supporting XR, accommodate the demanding requirements of these applications, such as high data rates, ultra-low latency, and power-efficient connectivity. As XR applications become more prevalent, the pressure on network infrastructure to efficiently manage these requirements intensifies.

In existing mechanisms, the buffer status report (BSR) reporting procedure is used to communicate the buffered data status, such as the size of the buffered data, across different logical channel groups (LCGs). The network scheduler uses the BSR to determine the uplink grants that is allocated to the user equipment (UE) for transmitting this buffered data. However, one of the key challenges is that the BSR does not include any information about the delay status of the buffered data. Buffered data at the UE may have varying levels of delay, as the data storage at the buffer may occur at different points in time. Further, different types of services have different packet delay budgets, which specify the maximum amount of delay data can experience before the data is discarded. If buffered data overshoots its packet delay budget or exceeds the time limit configured for data transmission, the data must be discarded.

The service data unit (SDU) is discarded if the associated timer expires before the SDU can be transmitted or when the successful delivery of the SDU is confirmed by a peer PDCP entity (e.g., through a PDCP status report). This lack of delay information in the existing BSR procedure can lead to inefficient scheduling, especially for delay-sensitive applications that rely on quick and timely data transmission. While the BSR reports the size of the buffered data, the size of the buffered data does not provide information about how long the data has been waiting in the buffer, which is a factor for the network to determine whether the data can still be transmitted without violating the delay budget.

To address the limitations of the existing BSR mechanism, the delay status report (DSR) mechanism has been introduced. The DSR incorporates both delay information and the pertinent buffered data information to enable the network to make better scheduling decisions for delay-sensitive applications such as XR. However, one of the main challenges with the DSR mechanism is the potential insufficient availability of uplink resources. The DSR mechanism requires more bandwidth and resources to transmit not only the data information but also the additional delay information. In some scenarios, when there are issues with uplink resources, the random access procedure is initiated, which is used by the UE to gain access to the network However, random access procedure needs to be managed for different conditions related to DSR procedure and this is not yet addressed by the 3GPP specifications.

Thus, it is desired to address the above-mentioned disadvantages or other shortcomings or at least provide a useful alternative.

### SUMMARY

The principal object of the present disclosure herein is to provide a method and a UE for delay status reporting handling for the XR in a communication network system.

Another object of the present disclosure herein is to transmit the DSR medium access control (MAC) control element (CE) plus its sub header completely when there is at least one DSR pending and when uplink shared channel (UL-SCH) resources are available for a new transmission.

Another object of the present disclosure herein is to stop random access due to a pending scheduling request (SR) for the DSR that has no valid physical uplink control channel (PUCCH) resources configured and associated conditions to be fulfilled.

Another object of the present disclosure herein is to form a DSR when sufficient uplink grants are not available for the DSR MAC CE transmission.

Yet another object of the present disclosure herein is to cancel SR for the DSR upon DSR cancellation and cancel SR for the DSR that triggered a random access.

In an aspect, the objects are achieved by providing a method and a UE for the DSR handling for the XR in a communication network system. The method includes detecting, by a UE, a transmission of a MAC protocol data unit (PDU) or a cancellation of the DSR that triggered a SR for the DSR and stopping an ongoing random access procedure initiated due to the pending SR for the DSR, wherein the pending SR for the DSR lacks valid PUCCH resources (e.g., PUCCH resources for the SR are not configured for the UE).

In an embodiment, the UE receives an uplink (UL) grant for an MAC layer/entity. The uplink grant is used for transmitting the MAC PDU and the uplink grant is at least one of a configured uplink grant and a dynamic uplink grant addressed to a cell radio network temporary identifier (C-RNTI) and receiving of the uplink grant causes the MAC layer/entity to terminate the ongoing random access procedure.

In an embodiment, when the MAC PDU is transmitted using an uplink grant that is not provided by a random access response (RAR) or an uplink grant that is not determined for the transmission of a message A (MSGA) payload. The MAC PDU includes at least one of: all the PDCP service data units (SDUs) associated with the DSR, or a DSR MAC CE that includes delay information of all the SDUs associated with the DSR.

In an embodiment, the DSR that triggered the SR is cancelled when all the PDCP SDUs associated with the DSR have been discarded, and wherein the SR is triggered by a DSR procedure.

In an aspect, the objects are achieved by providing a UE for the DSR handling for the XR in the communication network system. The UE a memory, a processor and a DSR controller, connected to the memory and the processor. The DSR controller detects a transmission of a MAC PDU or a cancellation of the DSR that triggered a SR for the DSR. Further, The DSR controller stops an ongoing random access procedure initiated due to the pending SR for the DSR, wherein the pending SR for the DSR lacks configuration of valid PUCCH resources.

The DSR controller receives an UL grant for an MAC layer/entity. The uplink grant is used for transmitting the MAC PDU, and the uplink grant is at least one of a configured uplink grant and a dynamic uplink grant addressed to a C-RNTI, and wherein receiving of the uplink grant causes the MAC layer/entity to terminate the ongoing random access procedure.

The DSR controller determines whether the MAC PDU is transmitted using an uplink grant that is not provided by a RAR or an uplink grant that is not determined for the transmission of a MSGA payload, wherein the MAC PDU includes at least one of: all the PDCP SDUs associated with the DSR, or a DSR MAC CE that includes delay information of all the SDUs associated with the DSR.

The DSR controller checks the DSR that triggered the SR is cancelled when all the PDCP SDUs associated with the DSR have been discarded, and wherein the SR is triggered by a DSR procedure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The present disclosure is illustrated in the accompanying drawings, throughout which like reference letters indicate corresponding parts in the various figures. The embodiments herein will be better understood from the following description with reference to the drawings, in which:

FIG. 1 illustrates a UE for enhanced DSR handling for an XR in a communication network system according to embodiments as disclosed herein;

FIG. 2 illustrates a flowchart of a method for enhanced DSR handling for the XR in the communication network system according to embodiments as disclosed herein;

FIG. 3 illustrates a flowchart of a method for an enhanced random access procedure stopping approach in conjunction with DSR cancellation at the MAC layer/entity for the XR in the communication network system according to embodiments as disclosed herein;

FIG. 4 illustrates a flowchart of a method for initiating a random access procedure due to a pending SR for a DSR and canceling the pending SR for the DSR according to embodiments as disclosed herein;

FIG. 5 illustrates a flowchart of a method for initiating a random access procedure due to a pending SR for a different DSR according to the priority levels of the LCG according to embodiments as disclosed herein;

FIG. 6 illustrates a flowchart of a method for the transmission of the complete DSR MAC CE according to embodiments as disclosed herein;

FIG. 7 illustrates a flowchart of a method for the transmission of the partial DSR MAC CE according to embodiments as disclosed herein;

FIG. 8 illustrates a structure of a UE according to an embodiment of the present disclosure; and

FIG. 9 illustrates a structure of a base station according to an embodiment of the present disclosure.

### DETAILED DESCRIPTION

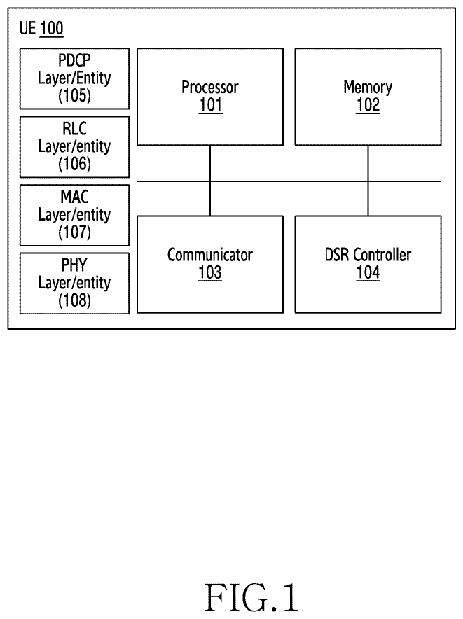

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is existing in the field, embodiments can be described and illustrated in terms of blocks which carry out a described function or functions. These blocks, which can be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor (1001) (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. can be used herein to describe various elements, these elements should not be limited by these terms. These terms are generally only used to distinguish one element from another.

In the rapidly evolving landscape of wireless communications, the integration of XR applications poses unique challenges, particularly in terms of ensuring timely data delivery and efficient network resource utilization. XR applications, which encompass AR, VR, and MR, demand high data throughput and low latency to provide seamless user experiences. The existing system, as defined in the 3GPP TS 38.321 V18.0.0 standard, attempts to address these demands through a Delay status reporting mechanism. However, this system has notable limitations that can hinder the performance of XR applications, especially for the cases when sufficient uplink resources are not available to accommodate a DSR and when a random access procedure needs to be managed for different conditions related to the DSR procedure.

Network schedules resources for the transmission of data from UE. Network needs to be aware of how much buffer is accumulated at the UE and the amount of delay that buffer data can tolerate. UE can be configured with many LCGs and different applications can be mapped to different LCGs. The UE may convey this information pertaining to the relevant LCG. DSR has a structure where LCGs specific delay and buffer information can be conveyed. DSRs occupies some space and if UE does not have resources even to send the DSR itself then SR is triggered which is a message sent by the UE to request uplink resources from the network, and the SR is transmitted over the PUCCH. PUCCH is the physical uplink control channel that the UE uses to send various types of control information, including the SR. But if the resources are not configured for SR, then UE cannot send SR and triggers a random access procedure.

In existing 5G systems, the random access procedure is employed to allow UE to establish initial communication and/or achieve time synchronization with the network when the UE needs to transmit data. This procedure starts when a device sends a random access preamble (MSG1) to which the network responds with a random access response (RAR or MSG 2), along with giving the device the uplink resources to continue the communication. The device then sends a radio resource control (RRC) connection request message or message 3 (MSG3) to confirm the connection. Further, the network provides RRC connection setup (MSG4) and grants the requested resources to the device. Apart from 4-step random access procedure, there is also 2-step random access procedure, wherein MSG1 and MSG3 are clubbed in MSGA and MSG2 and MSG4 are clubbed into MSGB.

To overcome these limitations, the provided disclosure introduces an enhanced method and UE for delay status reporting handling tailored for the XR in wireless networks which require extremely low-latency performance and high-quality data throughput. This method involves stopping random access procedure triggered due to a pending SR for the DSR for extended reality in the wireless networks. By stopping the random access procedure, the system avoids unnecessary network congestion and ensures that resources are used more efficiently. XR applications require extremely low-latency performance and high-quality data throughput, are especially sensitive to delays or interruptions in service.

The existing mechanism, as outlined in 3GPP TS 38.321, is designed to handle uplink resources and delay-sensitive applications in wireless networks. However, it faces several significant drawbacks when sufficient uplink resources are not available for transmitting the DSR or when the random access procedure initiated due to a pending SR for DSR is subject to different conditions of the DSR procedure. An uplink grant is an allocation of uplink resources provided by the network to the UE so the UE can send data to the network.

Embodiments disclosed herein provides a system and method for DSR handling for XR in a communication network system. The provided method includes stopping random access procedure triggered due to a SR for DSR. Further, the method includes forming a DSR when sufficient uplink grants are not available for DSR MAC CE transmission.

Accordingly, embodiments herein provide a method and system for packet discard handling for extended reality in the wireless networks.

However, the existing mechanism (i.e., 3GPP TS 38.321) suffers some drawbacks when sufficient uplink resources are not available to accommodate a DSR and when a random access procedure is stopped due to DSR cancellation.

Unlike the conventional system and methods, the provided method provides an enhanced DSR handling mechanism for XR in the wireless networks.

Referring now to the drawings, and more particularly to FIGS. 1 through 7, there are shown preferred embodiments.

FIG. 1 illustrates a UE (100) for an enhanced DSR handling mechanism for the XR in the communication network system. In an embodiment, the UE (100) includes a processor (101), a memory (102), a communicator (103), and the DSR controller (104).

Examples of the wireless communication network system include, but are not limited to, cellular networks (such as 2G, 3G, 4G, 5G, Beyond 5G (B5G)/6G, or advanced cellular networks), local area networks (LANs) (such as Wi-Fi, Li-Fi, etc.), personal area networks (PANs) (such as Bluetooth, Zigbee, Z-Wave, etc.), wide area networks (WANs) (such as satellite communication networks, long range wide area network, narrowband IoT, low-bandwidth communication for IoT, etc.), metropolitan area networks (MANs), machine-to-machine (M2M), Ad Hoc and mesh networks, emerging and advanced Networks.

Examples of the UE (100) can include, but are not limited to, consumer electronics (such as mobile phones and smartphones), tablets, wearable devices, television, computing devices (such as laptops, notebooks, desktops, workstations, etc.), IoT devices, automotive systems (such as connected cars, autonomous vehicles, vehicle-to-everything (V2X) communication devices, etc.), enterprise devices such as robotics, specialized equipment (such as medical devices, public safety devices, etc.), media devices (such as gaming consoles, streaming devices, etc.).

Further, the UE (100) is equipped with sensors and interfaces, including accelerometers, gyroscopes, cameras, and microphones, to support XR applications such as AR, VR, and MR. These applications require high data rates and low latency. The UE (100) also supports edge computing, offloading intensive tasks to nearby servers to reduce processing load and latency. Accelerometers and gyroscopes ensure precise motion tracking and orientation detection for a seamless XR experience. These sensors detect slight movements, enhancing interactivity. In VR, gyroscopes track head movements for natural navigation, while in AR, accelerometers help overlay digital information accurately. Cameras and microphones further enhance XR capabilities by providing visual and auditory inputs. Cameras capture real-world visuals for AR, ensuring sharp digital overlays. Microphones enable voice commands and spatial audio. In MR, spatial audio provides directional sound cues, making virtual elements feel real.

The UE (100) includes a protocol stack of mobile communication network systems like a PDCP layer/entity (105), an RLC layer/entity (106), a MAC layer/entity (107), and a physical (PHY) layer/entity (108). The PDCP layer/entity (105) is responsible for header compression, encryption, and integrity protection of data packets, ensuring secure and efficient data transmission. The RLC layer (106) manages the segmentation and reassembly of data packets, as well as error correction through automatic repeat request (ARQ) mechanisms, which are used for maintaining data integrity in the XR applications. The MAC layer (107) handles the scheduling and prioritization of data packets, coordinating access to the shared wireless medium to optimize network resource utilization. The PHY layer (108) is responsible for the modulation and demodulation of signals, as well as the transmission and reception of data over the air interface, utilizing advanced techniques such as orthogonal frequency division multiplexing (OFDM) and beamforming to enhance signal quality and coverage.

The processor (101) is responsible for executing instructions and managing the overall operation of the UE (100), including the enhanced SDU discard mechanism. The processor (101) communicates with the memory (102), the communicator (103), and the DSR controller (104). The processor (101) is configured to execute instructions stored in the memory (102) and to perform various processes for real-time data processing in XR applications. The processor (101) may include one or a plurality of processors, maybe a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

The memory (102) stores the operating system, application software, and temporary data used by the processor (101). The memory (102) stores physical downlink control channel (PDCCH) information, downlink control information (DCI) information, and physical downlink shared channel (PDSCH) information. The memory (102) stores instructions to be executed by the processor (101). The memory (102) may include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (102) may in some examples be considered a non-transitory storage medium. The term non-transitory may indicate that the storage medium is not embodied in a carrier wave or a propagated signal. However, the term non-transitory should not be interpreted that the memory (102) is non-movable. In some examples, the memory (102) can be configured to store larger amounts of information than the memory. In an example, a non-transitory storage medium may store data that can over time change (e.g., in random access memory (RAM) or cache).

The communicator (103) facilitates wireless communication with the network, supporting various communication protocols such as long term evolution (LTE), 5G, 6G, and Wi-Fi, and it may include multiple antennas for multiple input multiple output (MIMO) operations to enhance data throughput and reliability. Further, the communicator (103) is configured for communicating internally between internal hardware components and with external devices (client device) via one or more networks. The communicator (103) includes an electronic circuit specific to a standard that enables wired or wireless communication.

The DSR controller (104) is specialized hardware designed to handle the transmission of DSR, ensuring that XR data streams are delivered with minimal latency and packet loss. The DSR controller (104) detects the transmission of a MAC PDU, which encapsulates user data (PDCP SDUs) and/or control information (DSR MAC CE), at the MAC layer/entity (107) from the UE (100) to the network. It also detects the cancellation of the DSR that triggered an SR for the DSR. Upon detection, the DSR controller (104) stops an ongoing random access procedure that was initiated due to the pending SR for the DSR when the pending SR for the DSR lacks configuration of valid PUCCH resources. This ensures that the UE (100) does not waste resources on the random access procedure, as the MAC PDU has been transmitted to the network, or the DSR that triggered the SR has been cancelled, and there are no PDCP SDUs available to transmit to the network.

The DSR controller (104) receives an uplink grant for a MAC layer/entity (107), which is used for transmitting the MAC PDU. The uplink grant can be at least one of a configured uplink grant or a dynamic uplink grant addressed to a C-RNTI. Receiving the uplink grant causes the MAC layer/entity (107) to terminate the ongoing random access procedure. The configured uplink grant pre-allocates uplink resources to the UE (100) to transmit at regular intervals. If this grant can accommodate all the PDCP SDUs associated with the DSR or carry the DSR MAC CE, which conveys delay information for all the SDUs associated with the DSR, then the DSR Controller (104) stops the ongoing random access procedure.

The dynamic uplink grant addressed to a C-RNTI allocates uplink resources to a particular UE (100) dynamically, based on the current traffic demands and network conditions. When this grant is used to transmit all the PDCP SDUs associated with the DSR or DSR MAC CE which conveys delay information for all the SDUs associated with the DSR, the DSR controller (104) stops the ongoing random access procedure.

In an embodiment, the DSR controller (104) ensures that the transmission of the MAC PDU may take place using an uplink grant that is not provided by a RAR or an uplink grant that is not determined for the transmission of a MSGA payload. In this scenario, the MAC PDU can include all the PDCP SDUs associated with the DSR, which are the packets received from the higher layers to be transmitted, or the DSR MAC CE that includes delay information of all the PDCP SDUs associated with the DSR. When a valid UL grant other than the one provided by the RAR message or determined for the transmission of the MSGA payload is available to transmit the MAC PDU, there is no need to continue the random access procedure, ensuring that resources are not wasted.

The DSR controller (104) also cancels the DSR procedure that triggered the SR for uplink resources when all the PDCP SDUs associated with the DSR have been discarded. By canceling the DSR procedure when the associated PDCP SDUs are discarded, the network avoids allocating resources for data transmission that is no longer needed.

The DSR controller (104) determines that the DSR MAC CE generated by the UE (100) cannot be accommodated in the uplink resources granted by the network. When no pending SR has already been triggered by a DSR procedure for the same logical channel of the LCG, a SR for DSR is triggered, and the DSR controller (104) initiates a random access procedure due to the pending SR for the DSR when no valid PUCCH resources are configured to request resources for transmitting the SR for DSR and cancels the pending SR for the DSR as the random access procedure takes responsibility for the resources request.

An existing pending SR for the same logical channel is checked by the DSR controller (104). When there is no pending SR, a new SR can be triggered for a different DSR associated with the same logical channel. The priority of the LCG associated with the pending SR is checked by the DSR controller (104) and compared with the LCG priority of the ongoing random access procedure. If the LCG associated with the pending SR for the different DSR has a higher priority than the LCG associated with the ongoing random access procedure, the DSR controller (104) triggers a new SR for the different DSR. Else, if the LCG associated with the pending SR for the different DSR has a lower priority than the LCG associated with the ongoing random access procedure, the DSR controller (104) refrains from initiating the new random access procedure and continues with the ongoing random access procedure, provided the DSR has a higher priority LCG compared to the pending SR for the different DSR.

The DSR controller (104) cancels the new SR for a different DSR for the same logical channel of the LCG when no valid PUCCH resources are configured for the new SR, as PUCCH resources are used by the UE (100) to communicate control information such as SRs. Without these resources, the UE (100) cannot initiate the SR for the DSR. Despite the lack of PUCCH resources, the DSR controller (104) does not initiate a new random access procedure for the new SR while a previous random access procedure is ongoing.

The DSR controller (104) cancels the pending SR for a DSR when the pertinent DSR is cancelled. This cancellation occurs when the uplink grant can accommodate a MAC PDU that includes either all the SDUs associated with the DSR, meaning that the uplink resources allocated to the UE (100) handle the transmission of all the SDUs that are part of the DSR, or a DSR MAC CE that includes delay information of all the SDUs associated with the DSR. When the delay information, comprising a remaining time field and a buffer size field, is successfully transmitted, the DSR procedure is complete and considered cancelled. The remaining time field indicates how much time is left before an SDU is ready for transmission, and the buffer size field indicates how much data is waiting to be transmitted in the buffer. If all the SDUs associated with the DSR are discarded, the DSR process is no longer necessary, and the DSR controller (104) cancels the triggered DSR.

The DSR controller (104) determines that at least one DSR is pending and UL-SCH resources are available for a new transmission. Then the DSR controller (104) determines whether the available UL-SCH resources can completely accommodate a DSR MAC CE plus its sub-header as a result of logical channel prioritization. After successful determination, the DSR controller (104) instructs the multiplexing and assembly procedure to generate the DSR MAC CE. This procedure ensures that the delay information of all LCGs that have pending DSRs is included in the DSR MAC CE. The DSR controller (104) transmits the generated complete DSR MAC CE plus its sub-header, which accommodates the delay information for all pending DSRs of the corresponding LCGs. However, in cases where the DSR controller (104) determines the complete DSR MAC CE cannot be accommodated in the uplink resources, and when there is no pending SR already triggered by the DSR procedure for the same logical channel as this DSR, the MAC layer/entity (107) of the UE (100) triggers an SR.

The DSR controller (104) determines that a DSR is pending and that available UL-SCH resources can accommodate a DSR MAC CE plus its sub-header either partially or completely. Logical channel prioritization plays a key role in determining which logical channel and associated DSR is processed first when resources are limited. After successful determination, the DSR controller (104) instructs the multiplexing and assembly procedure to generate the DSR MAC CE and transmits the generated complete DSR MAC CE plus its sub-header, which accommodates the delay information of all LCGs that have pending DSRs are accommodated within the DSR MAC CE or the DSR controller (104) instructs the multiplexing and assembly procedure to generate the DSR MAC CE and transmits the generated partial DSR MAC CE for at least one pending DSR among all pending DSRs of corresponding LCGs and cancels the DSR accommodated in the DSR MAC CE. For the remaining pending DSRs that are not cancelled and have no pending SR already triggered by the DSR procedure for the LCGs, the DSR controller (104) triggers the SR.

In an embodiment, one or more permutations or combinations of the embodiments described further in the disclosure can be utilized for the DSR handling mechanism.

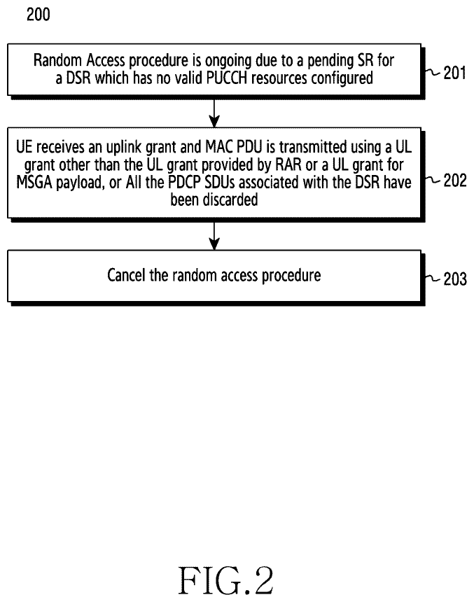

FIG. 2 illustrates a flowchart (200) of a mechanism for an enhanced DSR handling for the XR in the communication network systems according to embodiments as disclosed herein.

At step 201, the random access procedure is ongoing due to a pending SR for a DSR which has no valid PUCCH resources configured.

At step 202, the UE (100) receives an uplink grant and MAC PDU is transmitted using a UL grant other than the UL grant provided by random access response (RAR) or a UL grant for MSGA payload, or all the PDCP SDUs associated with the DSR have been discarded.

In an embodiment, the MAC layer/entity (107) of the UE (100) may stop an ongoing random access procedure due to a pending SR for DSR, which has no valid PUCCH resources configured, if at least one of the conditions are met:
1) A MAC PDU is transmitted using an uplink (UL) grant other than a UL grant provided by random access response (RAR) or a UL grant determined as specified in 3GPP standard specification for the transmission of the MSGA payload, and this PDU includes either all the SDUs associated with the DSR or a DSR MAC CE that contains the delay information of all the SDUs associated with the DSR.
2) The DSR that triggered the SR has been cancelled when all the SDUs associated with the DSR have been discarded.

In an embodiment, an example of the specification is provided for handling of the random access procedure due to a pending SR for DSR, which has no valid PUCCH resources configured, as follows:

### Example 1

The MAC entity (107) may stop, if any, ongoing random access procedure due to a pending SR for DSR, which has no valid PUCCH resources configured, if:
1) a MAC PDU is transmitted using a UL grant other than a UL grant provided by random access response or a UL grant determined as specified in 3GPP standard specification for the transmission of the MSGA payload, and this PDU includes either all the SDUs associated with the DSR or a DSR MAC CE that contains the delay information of all the SDUs associated with the DSR; or
2) the DSR that triggered the SR has been cancelled when all the SDUs associated with the DSR have been discarded.

In an embodiment, the MAC entity (107) of the UE (100) may stop an ongoing random access procedure due to a pending SR for DSR, which has no valid PUCCH resources configured, if at least one of the conditions are met:
1) A MAC PDU is transmitted using a UL grant other than a UL grant provided by random access response or a UL grant determined as specified in 3GPP standard specification for the transmission of the MSGA payload, and this PDU includes a DSR MAC CE that contains the delay information of all the delay-critical SDUs up to (and including) the last event that triggered a DSR prior to the MAC PDU assembly.
2) The UL grant(s) can accommodate all pending data for transmission associated to the DSR.
3) The DSR that triggered the SR has been cancelled when all the SDUs associated with the DSR have been discarded.

In an embodiment, an example of the specification is provided for handling of the random access procedure due to a pending SR for DSR, which has no valid PUCCH resources configured, as follows:

### Example 2

The MAC entity (107) may stop, if any, ongoing random access procedure due to a pending SR for DSR, which has no valid PUCCH resources configured, if:
1) a MAC PDU is transmitted using a UL grant other than a UL grant provided by random access response or a UL grant determined as specified in 3GPP standard specification for the transmission of the MSGA payload, and this PDU includes a DSR MAC CE that contains the delay information of all the delay-critical SDUs up to (and including) the last event that triggered a DSR prior to the MAC PDU assembly;
2) the UL grant(s) can accommodate all pending data for transmission associated to the DSR; or
3) the DSR that triggered the SR has been cancelled when all the SDUs associated with the DSR have been discarded.

In an embodiment, the uplink grant is at least one of a configured uplink grant, which includes a predefined allocation of uplink resources to the UE (100), or a dynamic uplink grant addressed to a C-RNTI. The dynamic uplink grant is provided by the network, allowing the UE (100) to request resources dynamically and identify the specific UE requesting the resources. Upon receiving the uplink grant, the UE (100) successfully acquires the resources for transmitting the MAC PDU and terminates the ongoing random access procedure.

In an embodiment, the uplink grant that is considered for the MAC layer/entity (107) to stop an ongoing random access procedure due to a pending SR for the DSR, which has no valid PUCCH resources configured, includes a configured uplink grant.

In an embodiment, the uplink grant that is considered for the MAC entity to stop an ongoing random access procedure due to a pending SR for DSR, which has no valid PUCCH resources configured, may include a configured uplink grant.

In an embodiment, the uplink grant that is considered for the MAC entity to stop an ongoing random access procedure due to a pending SR for DSR, which has no valid PUCCH resources configured, may include a dynamic uplink grant addressed to C-RNTI.

In an embodiment, the uplink grant that is considered for the MAC entity to stop an ongoing random access procedure due to a pending SR for DSR, which has no valid PUCCH resources configured, may include a dynamic uplink grant or a configured uplink grant for a cell other than the cell where random access procedure is triggered e.g., a Scell, a PScell.

At step 203, the MAC layer/entity (107) of the UE (100) cancels the random access procedure.

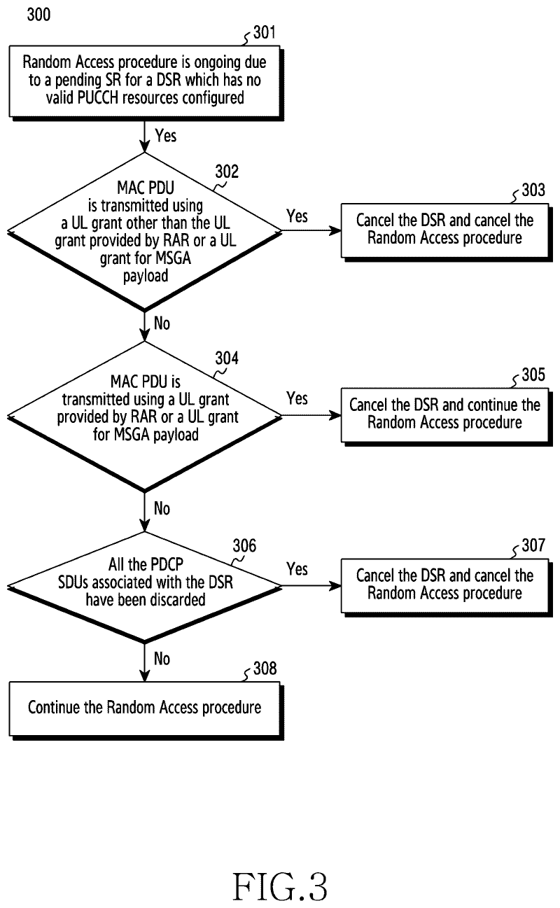

FIG. 3 illustrates a flowchart (300) of a method for an enhanced random access procedure stopping approach in conjunction with DSR cancellation at the MAC layer/entity (107) for the XR in the communication network systems according to embodiments as disclosed herein.

At step 301, the random access procedure is ongoing due to a pending SR for a DSR which has no valid PUCCH resources configured. This involves using the random access procedure as a fallback mechanism in scenarios where the SR cannot be transmitted due to the lack of valid PUCCH resources configured. The initiation of the random access procedure ensures that the UE (100) can still attempt to access the network and transmit the necessary data even when the preferred resources are unavailable.

At step 302, the UE (100) determines whether a MAC PDU is transmitted using a UL grant other than a UL grant provided by random access response or a UL grant determined as specified in 3GPP standard specification for the transmission of the MSGA payload. The UE (100) ensures that the transmitted MAC PDU includes either all the PDCP SDUs associated with the DSR or a DSR MAC CE that includes the delay information of all the SDUs associated with the DSR.

At step 303, the MAC layer/entity (107) of the UE (100) cancels the DSR and the random access procedure.

At step 304, the UE (100) determines whether a valid UL grant provided by RAR or a UL grant determined as specified in 3GPP standard specification for the transmission of the MSGA payload is available to transmit the MAC PDU. This is similar to step 302, but it specifically checks for the availability of uplink grants provided by the RAR or as specified in 3GPP standard specification.

At step 305, the MAC layer/entity (107) of the UE (100) cancels the DSR and continues the random access procedure. In an embodiment, the pending DSR is cancelled when a MAC PDU is transmitted using an uplink grant provided by random access response or an uplink grant determined for the transmission of the MSGA payload, and this PDU includes either all the SDUs associated with the DSR or a DSR MAC CE that includes the delay information of all the SDUs associated with the DSR.

At step 306, the UE (100) determines whether all the PDCP SDUs associated with the DSR have been discarded.

At step 307, the MAC layer/entity (107) of the UE (100) cancels the DSR and random access procedure.

At step 308, when all the PDCP SDUs associated with the DSR are not discarded, the UE (100) continues the random access procedure.

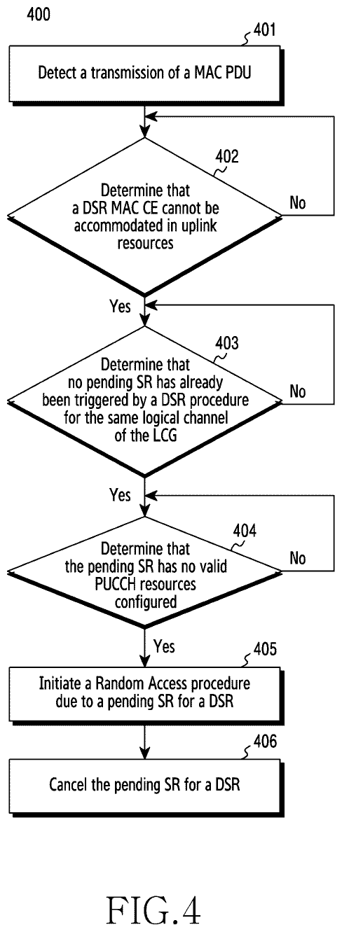

FIG. 4 illustrates a flowchart (400) of a method for initiating a random access procedure due to a pending SR for a DSR and cancelling the pending SR for the DSR according to embodiments as disclosed herein.

At step 401, the UE (100) detects a transmission of a MAC PDU that includes either all the PDCP SDUs associated with the DSR or a DSR MAC CE that includes the delay information of all the PDCP SDUs associated with the DSR.

At step 402, the UE (100) determines the DSR MAC CE could not be accommodated in the uplink resources.

At step 403, the UE (100) determines that no pending SR has already been triggered by the DSR procedure for the same logical channel of the LCG.

At step 404, the UE (100) determines that the pending SR has no valid PUCCH resources configured.

At step 405, the UE (100) initiates a random access procedure due to the pending SR for the DSR, which acts as a fallback mechanism in scenarios where the SR cannot be transmitted due to the lack of valid PUCCH resources configured.

At step 406, when a random access procedure is initiated due to a pending SR for DSR, which has no valid PUCCH resources configured, the pending SR is cancelled.

In an embodiment, when a random access procedure is initiated due to a pending SR for DSR, which has no valid PUCCH resources configured, the pending SR is cancelled. Further, while the random access procedure is ongoing, if DSR MAC CE could not be accommodated in the uplink resources and if there is no pending SR already triggered by the DSR procedure for the same logical channel as of this DSR, the MAC layer/entity (107) of the UE (100) does not trigger a SR for DSR for the same logical channel of the LCG.

In an embodiment, when a random access procedure is initiated due to a pending SR for DSR, which has no valid PUCCH resources configured, the pending SR is cancelled. Further, while the random access procedure is on-going, if DSR MAC CE could not be accommodated in the uplink resources and if there is no pending SR already triggered by the DSR procedure for a logical channel of the LCG as of this DSR, the MAC layer/entity (107) of the UE (100) does not trigger a SR for any logical channel of the LCG.

In an embodiment, when a random access procedure is initiated due to a pending SR for DSR, which has no valid PUCCH resources configured, and the pending SR is cancelled. Further, while the random access procedure, if DSR MAC CE could not be accommodated in the uplink resources and if there is no pending SR already triggered by the DSR procedure for the same logical channel as of this DSR, the MAC layer/entity (107) of the UE (100) triggers a SR for DSR for the same logical channel of the LCG. Furthermore, if the pending SR for DSR has no valid PUCCH resources configured, no new random access procedure is initiated while already the previous random access procedure is ongoing. The pending SR is cancelled when the pertinent DSR is cancelled, i.e., when uplink grant can accommodate MAC PDU that includes either all the PDCP SDUs associated with the DSR or a DSR MAC CE that contains the delay information of all the SDUs associated with the DSR or when all the SDUs associated with the DSR have been discarded.

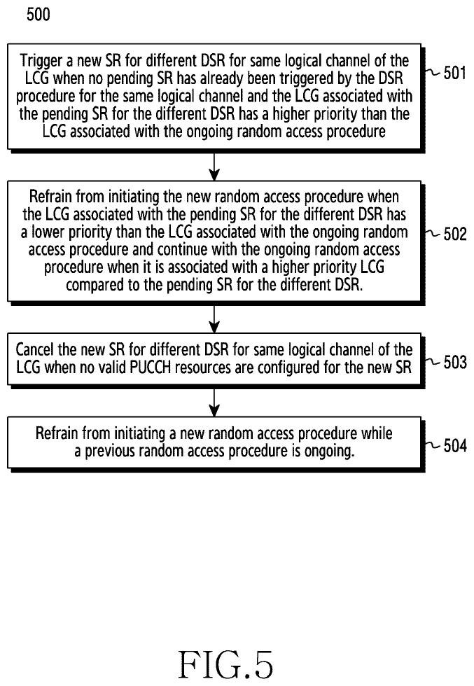

FIG. 5 illustrates a flowchart (500) of a method for initiating a random access procedure due to a pending SR for a different DSR according to the priority levels of the LCG according to embodiments as disclosed herein.

At step 501, when a random access procedure is ongoing which was triggered due to a pending SR for DSR, which has no valid PUCCH resources configured, and a new random access procedure is triggered due to a pending SR for different DSR associated with a LCG/logical channel having higher priority than the LCG/logical channel associated with the ongoing random access procedure and which has no valid PUCCH resources configured, the UE (100) stops the current random access procedure and starts with a new random access procedure.

At step 502, when a random access procedure is ongoing, which was triggered due to a pending SR for the DSR which has no valid PUCCH resources configured, and a new random access procedure is triggered due to a pending SR for a different DSR associated with the LCG/logical channel having lower priority than the LCG/logical channel associated with the ongoing random access procedure and which has no valid PUCCH resources configured, the UE (100) continues with the current random access procedure and does not initiate a new random access procedure.

In an embodiment, if a random access procedure is ongoing which was triggered due to a pending SR for DSR, which has no valid PUCCH resources configured, and a new random access procedure is triggered due to a pending SR for different DSR associated with a LCG/logical channel, which has no valid PUCCH resources configured, the UE (100) continues with the current random access procedure and does not initiate a new random access procedure.

At step 503, the UE (100) cancels the new SR for a different DSR for the same logical channel of the LCG when no valid PUCCH resources are configured for the new SR. This ensures that the system does not waste resources on attempting to initiate a random access procedure that cannot be completed due to the lack of valid PUCCH resources.

At step 504, when the new SR for a different DSR has no valid PUCCH resources configured, no new random access procedure is initiated while the previous random access procedure is already ongoing. This step helps in maintaining the efficiency of the network by preventing the initiation of redundant procedures that may not be successful.

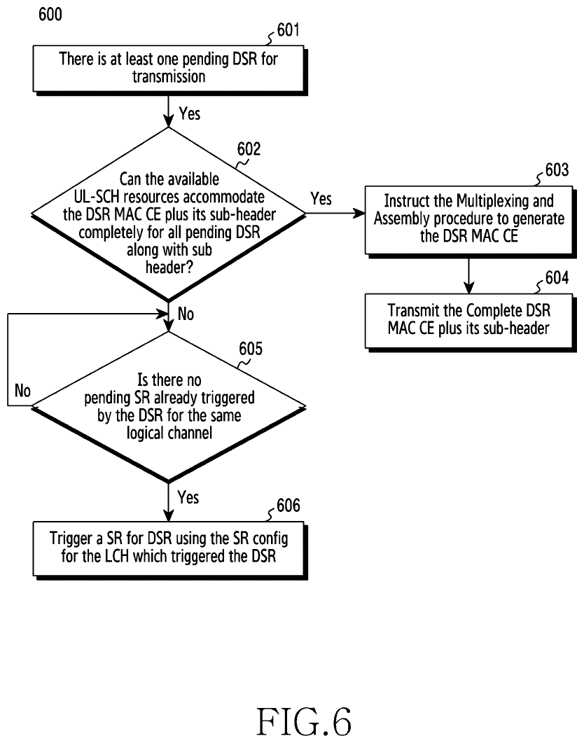

FIG. 6 illustrates a flowchart (600) of a method for the transmission of the complete DSR MAC CE according to embodiments disclosed herein.

In an embodiment, at step 601, the UE (100) detects that there is at least one DSR pending and if UL-SCH resources are available for a new transmission. In step 602, the UE (100) determines whether the available UL-SCH resources can accommodate the DSR MAC CE plus its sub-header completely as a result of logical channel prioritization. The MAC layer/entity (107) of the UE (100) instructs the multiplexing and assembly procedure to generate the DSR MAC CE at step 603. At step 604, the UE (100) determines the complete DSR MAC CE when the delay information (remaining time field and buffer size field) for all the pending DSRs of the corresponding logical channel groups (LCGs) can be accommodated in the DSR MAC CE. If the complete DSR MAC CE could be accommodated in the uplink resources, the UE (100) determines at step 605 whether there is no pending SR already triggered by the DSR procedure for the same logical channel as of this DSR. Further, at step 606, the MAC layer/entity (107) of the UE (100) triggers a scheduling request.

### Example 3

If there is at least one DSR pending, the MAC entity may:
1> if UL-SCH resources are available for a new transmission and the UL-SCH resources can accommodate the DSR MAC CE plus its sub header completely as a result of logical channel prioritization:
2> instruct the multiplexing and assembly procedure to generate the DSR MAC CE;
1> else if there is no pending SR already triggered by the DSR procedure for the same logical channel as of this DSR:
2> trigger a scheduling request.

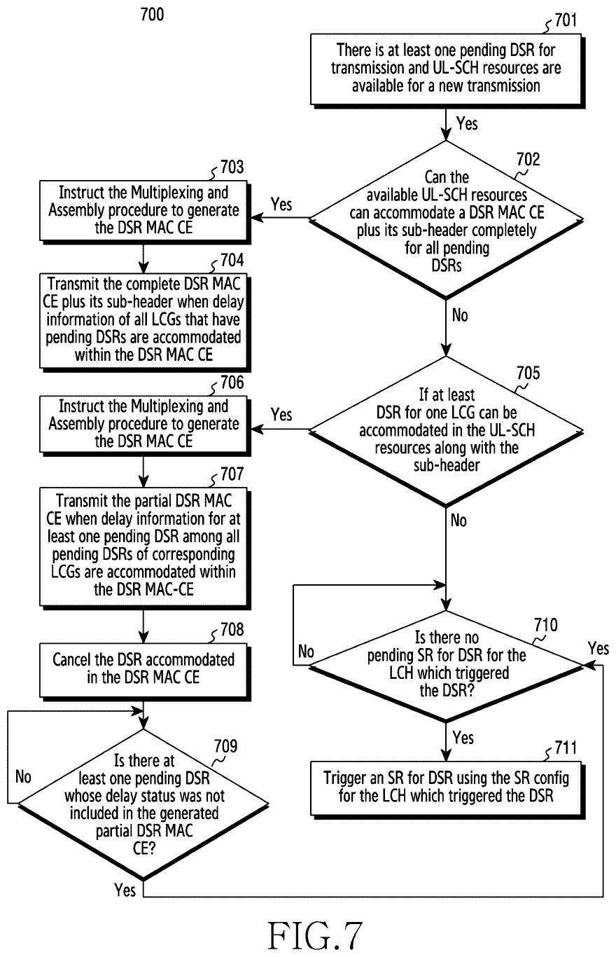

FIG. 7 illustrates a flowchart (700) of a method for the transmission of the partial DSR MAC CE according to embodiments as disclosed herein.

In an embodiment, at step 701, the UE (100) detects whether there is at least one DSR pending and the UL-SCH resources are available for a new transmission. At step 702, the UE (100) determines whether the UL-SCH resources can accommodate the DSR MAC CE plus its sub-header completely as a result of logical channel prioritization. If true, the MAC layer/entity (107) of the UE (100) instructs the multiplexing and assembly procedure to generate the DSR MAC CE at step 703 and at step 704, the UE (100) transmits the complete DSR MAC CE plus its sub-header when delay information of all LCGs that have pending DSRs are accommodated within the DSR MAC CE, wherein delay information comprises a remaining time field and a buffer size field.

If false, at step 705, the UE (100) determines if at least DSR for one LCG can be accommodated in the UL-SCH resources along with the sub-header. The MAC layer/entity (107) of the UE (100) instructs the multiplexing and assembly procedure to generate the DSR MAC CE at step 706 and at step 707, the UE (100) transmits the partial DSR MAC CE when the delay information (remaining time and buffer size fields) for at least one pending DSR among all pending DSRs of corresponding LCGs can be accommodated in the DSR MAC CE and for at least one pending DSR among all pending DSRs of the corresponding LCGs cannot be accommodated in the DSR MAC CE. The UE (100) cancels the DSR which is accommodated in the DSR MAC CE at step 708. At step 709, the UE (100) determines that there is at least one DSR pending and not yet cancelled.

At step 710, the UE (100) determines whether there is no pending SR already triggered by the DSR procedure for the same logical channel as of this DSR. The MAC layer/entity (107) of the UE (100) triggers a SR at step 711.

### Example 4

If there is at least one DSR pending, the MAC entity may:
1> if UL-SCH resources are available for a new transmission and the UL-SCH resources can accommodate the DSR MAC CE plus its sub header for at least one DSR for LCG as a result of logical channel prioritization:
2> instruct the multiplexing and assembly procedure to generate the DSR MAC CE;
1> if there is at least one DSR pending and not yet cancelled and if there is no pending SR already triggered by the DSR procedure for the same logical channel as of this DSR:
2> trigger a scheduling request.

In an embodiment, whether to instruct the multiplexing and assembly procedure to generate the DSR MAC CE partially or completely based on the availability of the amount of uplink resources is made by the UE (100) implementation. That is, it is up to the UE (100) implementation to support partial or complete DSR reporting. The UE (100) may implement the UE (100) capability to support partial DSR reporting through an optional capability without signaling to the network or an optional capability with signaling to the network or a mandatory capability. The signaling may be carried in a UE (100) capability information message or may be associated with the UE (100) capability to support the XR feature and/or DSR feature.

In an embodiment, the MAC layer/entity (107) of the UE (100) triggers a DSR for the LCG if the following conditions are met:
1) The smallest remaining value of the PDCP discardTimers among all the data buffered for the LCG that has not been transmitted in any MAC PDU or reported as data volume in a DSR MAC CE becomes below the remaining TimeThreshold of the LCG; and
2) There is no DSR pending for the LCG since the last transmission of a DSR MAC CE, including delay information for the LCG.

### Example 5

If an LCG is configured for delay status reporting, the MAC entity may:
1> if the smallest remaining value of the PDCP discardTimers among all the data buffered for the LCG that has not been transmitted in any MAC PDU or reported as data volume in a DSR MAC CE becomes below remaining TimeThreshold of the LCG; and
2> trigger a DSR for the LCG.

In an embodiment, if there is at least one DSR pending and if UL-SCH resources are available for a new transmission, and the UL-SCH resources can accommodate the DSR MAC CE plus its sub-header either partially or completely as a result of logical channel prioritization, the MAC layer/entity (107) of the UE (100) instructs the multiplexing and assembly procedure to generate the DSR MAC CE. The partial DSR MAC CE is determined when the delay information (remaining time field and buffer size field) for at least one pending DSR among all pending DSRs of the corresponding LCGs can be accommodated in the DSR MAC CE, and for at least one pending DSR among all pending DSRs of the corresponding LCGs cannot be accommodated in the DSR MAC CE. DSR which is accommodated in the DSR MAC CE is cancelled. Further, if there is more than one DSR pending and not yet cancelled, the MAC layer/entity (107) of the UE (100) triggers an scheduling request which the SR configuration of a logical channel chosen based on at least one of the following criteria: the logical channel (LCH) with the highest priority, a configured LCH, the LCH which triggered the first pending DSR, the LCH which has the lowest delay value.

In an embodiment, if there is at least one DSR pending and if UL-SCH resources are available for a new transmission, and the UL-SCH resources cannot accommodate the DSR MAC CE plus its sub-header completely as a result of logical channel prioritization, the MAC layer/entity (107) of the UE (100) instructs the multiplexing and assembly procedure to generate the partial DSR MAC CE. The MAC layer/entity (107) considers the pending DSRs in the order of descending priority levels of the LCG/LCHs which triggered the DSR for constructing the MAC CE and accordingly builds the partial DSR MAC CE. In another embodiment, the UL resources or grant considered can be at least one of an uplink grant received in RAR, uplink grant determined for transmission of MSG1 payload, configured uplink grant, and dynamic uplink grant addressed to C-RNTI.

Hence, the provided solution disclosed above introduces an innovative solution to the DSR handling tailored for the XR applications. The provided solution aims to address the challenges associated with insufficient uplink resources and the need for efficient random access procedures, particularly in situations where uplink grants are unavailable to accommodate the transmission of DSR MAC CE.

The technical advantage of the present disclosure lies in its ability to enable an efficient approach for delay status reporting for the XR. The present disclosure improves the performance of both the UE and the network system for the XR applications. The reduction in unnecessary signaling and optimized resource allocation leads to a more responsive and reliable XR experience. This is particularly important in applications where low latency and high reliability are considered, such as in the VR, the AR, and other immersive technologies.

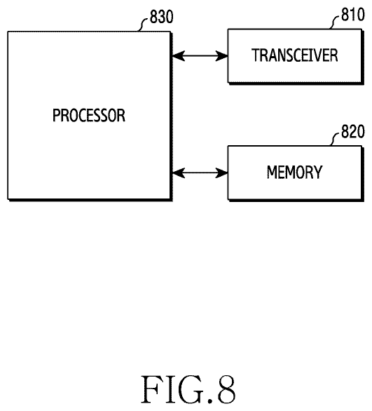

FIG. 8 illustrates a structure of a UE according to an embodiment of the present disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor.

The transceiver 810 collectively refers to a UE receiver and a UE transmitter, and may transmit/receive a signal to/from a base station. The signal transmitted or received to or from the base station may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station, and the processor 830 may determine a result of receiving the control signal and the data signal transmitted by the base station.

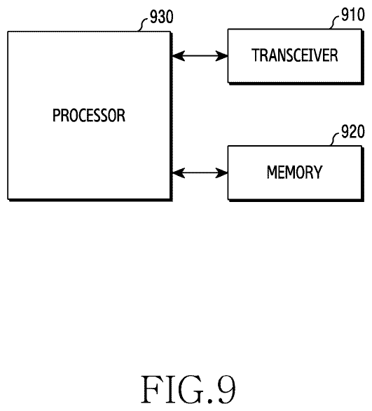

FIG. 9 illustrates a structure of a base station according to an embodiment of the present disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor.

The transceiver 910 collectively refers to a base station receiver and a base station transmitter, and may transmit/receive a signal to/from a terminal. The signal transmitted or received to or from the terminal may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A user equipment (UE) in a wireless communication system, the UE comprising:
a transceiver; and
a controller coupled with the transceiver, and configured to:
in case that there is no pending scheduling request (SR) already triggered by a delay status report (DSR) procedure for a same logical channel associated with the DSR procedure, trigger a SR for a DSR,
identify that the SR for the DSR has no valid physical uplink control channel (PUCCH) resources configured,
perform a random access procedure, and
cancel the SR for the DSR.

2. The UE of claim 1, wherein, in case that the SR for the DSR is triggered by the DSR procedure and the DSR procedure is cancelled, the SR is cancelled.

3. The UE of claim 1, wherein the controller is further configured to:
stop the random access procedure due to the SR for the DSR which has no valid PUCCH resources configured.

4. The UE of claim 3, wherein, in case that all of service data units (SDUs) associated with the DSR have been discarded, the random access procedure is stopped.

5. The UE of claim 3, wherein, in case that a medium access control (MAC) protocol data unit (PDU) is transmitted using an uplink (UL) grant other than a UL grant provided by random access response or a UL grant determined for a transmission of a message A (MSGA) payload, the random access procedure is stopped.

6. The UE of claim 5, wherein the MAC PDU includes one of a DSR MAC control element (CE) or all of SDUs associated with the DSR.

7. The UE of claim 1, wherein the controller is further configured to, in case that UL-shared channel (SCH) resources are available for a new transmission and the UL-SCH resources can accommodate a DSR MAC CE plus its subheader as a result of logical channel prioritization, perform a multiplexing and assembly procedure to generate the DSR MAC CE, and
wherein the DSR MAC CE includes delay information for all logical channel groups (LCGs) corresponding to pending DSRs.

8. A method performed by a user equipment (UE) in a wireless communication system, the method comprising:
in case that there is no pending scheduling request (SR) already triggered by a delay status report (DSR) procedure for a same logical channel associated with the DSR procedure, triggering a SR for a DSR;
identifying that the SR for the DSR has no valid physical uplink control channel (PUCCH) resources configured;
performing a random access procedure; and
cancelling the SR for the DSR.

9. The UE of claim 8, wherein, in case that the SR for the DSR is triggered by the DSR procedure and the DSR procedure is cancelled, the SR is cancelled.

10. The UE of claim 8, further comprising:
stopping the random access procedure due to the SR for the DSR which has no valid PUCCH resources configured.

11. The UE of claim 10, wherein, in case that all of service data units (SDUs) associated with the DSR have been discarded, the random access procedure is stopped.

12. The UE of claim 10, wherein, in case that a medium access control (MAC) protocol data unit (PDU) is transmitted using an uplink (UL) grant other than a UL grant provided by random access response or a UL grant determined for a transmission of a message A (MSGA) payload, the random access procedure is stopped.

13. The UE of claim 12, wherein the MAC PDU includes one of a DSR MAC control element (CE) or all of SDUs associated with the DSR.

14. The UE of claim 8, further comprising:
in case that UL-shared channel (SCH) resources are available for a new transmission and the UL-SCH resources can accommodate a DSR MAC CE plus its subheader as a result of logical channel prioritization, performing a multiplexing and assembly procedure to generate the DSR MAC CE,
wherein the DSR MAC CE includes delay information for all logical channel groups (LCGs) corresponding to pending DSRs.
